(19) United States
(12) Patent Application Publication
(10) Pub. No.: US 2011/0169985 A1
(43) Pub. Date: Jul. 14, 2011

(54) Method of Generating Seamless Mosaic Images from Multi-Axis and Multi-Focus Photographic Data

(75) Inventor: Eugene Henry Cooper, Vallejo, CA (US)

(73) Assignee: Four Chambers Studio, LLC

(21) Appl. No.: 12/842,000

(22) Filed: Jul. 22, 2010

Related U.S. Application Data
(60) Provisional application No. 61/228,154, filed on Jul. 23, 2009.

(51) Int. Cl. H04N 5/228; H04N 5/217

(52) U.S. Cl. 348/241; 348/222.1; 348/E05.031; 348/E05.078

(57) ABSTRACT

A system and method for generating seamless mosaic images from multi-axis and multi-focus photographic data of at least one subject is disclosed. The system is for capturing photographic data from at least one subject and to provide an array of photographic data in at least three dimensions. The method comprises the steps of performing axial capture of a plurality of images of the at least one subject, sorting the plurality of images into a plurality of folders for easier processing of the plurality of images, performing focus stacking process for analysis of images, performing depth calculations, extracting data and rendering a focus stacked image, performing post processing of the focus stacked images to enhance the images, performing photo mosaic stitching process for rendering a seamless image and performing post processing of the seamless image to correct errors of the seamless image and to add any desired enhancements to the seamless image.

### RELATED APPLICATIONS

This application is related to and claims priority from provisional patent application Ser. No. 61/228,154, filed Jul. 23, 2009.

### BACKGROUND OF THE INVENTION

1. Technical Field of the Invention

The present invention relates in general to mosaic photography. More specifically, the present invention relates to processes, systems, and computational technology for generating seamless mosaic imagery from multi-axis and multi-focus photographic data.

2. Description of the Related Art

Mosaic photography is the process of combining multiple photographic images with overlapping elements to produce a single segmented, generally high-resolution photograph. In this technique, multiple images are taken in a radial pattern around a central point of rotation (also known as the nodal point) on a pivot about the entrance pupil of the camera. At least as early as the late 1950s, space scientists manually stitched and assembled such photographs into a single merged photograph, although today stitched or merged photos are commonly created through the use of computer software. The advantage of such mosaic photographic technique is that it allows for higher resolution imagery to be captured than is possible with the limitations of the imaging device for a single photograph. One example of a system for automatically aligning images to form a mosaic image is disclosed in U.S. Pat. No. 5,649,032 issued to Burt on Dec. 7, 1999. This system sequentially executes an image alignment process, an editing process, and a combining process, such that from a sequence of images, the system automatically produces a seamless mosaic for various applications. Another example is disclosed in U.S. Pat. No. 5,796,861 issued to Vogt on Aug. 18, 1998, which describes a method for acquiring, mosaicing, cueing and interactively reviewing large-scale transmission, electron micrograph composite images. Individual frames are automatically registered and mosaiced together into a single virtual image composite, which is then used to perform automatic cueing of axons and axon clusters, as well as review and marking by qualified neuroanatomists. Statistics derived from the review process are used to evaluate the efficacy of the drug in promoting regeneration of myelinated nerve fibers. To produce near seamless results, most computer software requires nearly exact overlaps and identical exposures among images used. Generally, the software will calibrate the images to accommodate changes in perspective, vignetting, and other aberrations. Advanced computational algorithms further align, merge and render the final mosaic image, preferably seamlessly. Despite these accommodations, the technique has not been perfected. Shortcomings in the technique are very apparent when it is used to enhance the imaging of macroscopic and microscopic subjects.

The techniques for photographing macroscopic and microscopic subjects with existing equipment and software have significant limitations such as the resolution of the final image, the depth of field (i.e. the amount of the subject that remains in focus) throughout the final image, and a lack of any apparatus for accurately, rapidly, and repeatedly capturing high quantities of photographs of macroscopic and microscopic subjects. Furthermore, software applications for creating seamless mosaic imagery focus on using images that are captured in radial format (pivoting around a central point). For macroscopic and microscopic photography, images are captured in a planar or axial format where the camera film or sensor plane is kept perpendicular to the subject. An additional limitation becomes more apparent when a high degree of magnification is used with the technique. Here, the focal length of the lens is typically quite small, and cannot capture the entire subject with complete clarity and focus. That is, portions of the subject may be in focus while other portions of the subject may be out of focus. Consequently, it is extremely difficult if not impossible in many cases to photograph a macroscopic or microscopic subject in complete clarity and with the desired resolution necessary to image the entire subject.

The above limitation regarding focal length is so critical that it presents a problem for macro photography and photo microscopy even when the mosaic photography techniques are not employed. This is because a direct relationship exists between the focal length of a lens, the magnification of the object, and the depth of field. Thus, as the focal length of the lens increases, the magnification of an object increases, and the depth of field consequently decreases. Traditionally, when photographing an object with a macro lens or through a microscope, only a small area of the object appears in focus. As stated above, the optimal mosaic photograph has an image plane perpendicular to the subject for all photographs to be merged. Many microscopes are equipped for such photography and allow for three-axis movement. Typically, microscopes are adjustable along both the X-axis and Y-axis, and further allow for a focal length adjustment (f-axis) that changes either the Z-axis or the focal length directly. However, the movement in each axis is typically limited to manual controls. Using manual controls for photographing objects in three dimensions is extremely labor intensive and often results in human errors in the process. The limitation here then is the lack of a complete system to rapidly take a precise series of photographs in an automated manner in three or more axis of movement.

More recent advancements have automated the above process to some degree, allowing for the rapid capture of imagery in the X and Y planes. However, these systems fail to integrate three or more axes in the process of automatically capturing photographic imagery. This failure has prevented researchers, scientists, educators, photographers, and the general public from efficiently and accurately photographing macroscopic and microscopic objects in multiple dimensions. With regard to the depth of field limitations in macro photography and photo microscopy (regardless of whether the mosaic technique is used), advancements in computational software and photography techniques have provided some amount of relief. Such advancements generally combine a series of images each with a low depth of field into a single image having a high depth of field. Preferably, the photographs are taken from the same position in physical space and with varying, but equally spaced depths of field. This technique is commonly referred to as depth stacking or focus stacking and a similar technique is discussed in U.S. Pat. No. 4,700,298 issued to Palcic on Oct. 13, 1987. Problems with focus stacking arise because currently each software user is required to develop and implement a method of capturing precise imagery at varying focal lengths of equal intervals. The method consequently works well to merge a single series of photographs with different focal lengths into a single photograph. However, it fails to provide a solution for merging multiple sets of focus-stacked imagery wherein different adjacent sections of the subject are photographed.

One technique for automating the capture of imagery at precise and repeatable intervals is described in U.S. Pat. Application number 20090022421 entitled to Uyttendaele on Jan. 22, 2009. In this technique, a gigapixel image is generated from a set of images in raw format depicting different portions of a panoramic scene that has up to a full spherical field of view. The set of images is captured in radial format using a conventional digital camera that is equipped with a telephoto lens and is attached to a motorized head. The head is programmed to pan and tilt the camera in prescribed increments to individually capture the images at a plurality of exposures and with a prescribed overlap between images depicting adjacent portions of the scene. There is no suggestion or motivation to apply this technique to problems inherent with the focus stacking technique for macroscopic and microscopic subjects. U.S. Pat. No. 6,044,181, issued to Szeliski on Mar. 28, 2000, describes a method for estimating focal length and provides an apparatus for the construction of panoramic mosaic images. The focal length estimation method is accomplished by computing a planar perspective transformation between each overlapping pair of images, computing a focal length transformation from the planar perspective transformation, and computing a rotational transformation for each of the pair of images whereby a combination of the rotational transformation and the focal length transformation relates the respective image to a three-dimensional coordinate system. Registration errors between the pair of images are reduced by incrementally deforming the rotational transformation of one of the pair of images. The planar perspective transformation is a matrix of warp elements, and the focal length is computed as a function of the warp elements. The function is derivable by constraining the first two rows or the first two columns of the matrix to have the same norm and to be orthogonal. The focal length of one image of a pair of images is found by applying the constraint on the matrix columns, while the focal length of the other image of the pair is found by applying the constraint on the matrix rows. While this method does yield a focal length estimation, it does not provide a solution for increasing depth of field of a subject.

Combining seamless mosaic imagery techniques with focus stacking techniques yields even more problems. If the imagery is not precisely photographed, errors in alignment of a series of images often leads to discarding areas of the photographs that do not have sufficient information and resolution is lost. Another limitation resides with the lack of ability and computational technology to combine a series of focus stacked imagery into a single seamless mosaic. Additionally, the lack of apparatus for capturing the imagery in an automated, efficient, and precise manner is another key limitation of the focus stacking software and process.

Hence, it can be seen that there is a need for a complete unified process for bringing disparate techniques together for the purpose of creating high resolution, large depth of field images. This high precision apparatus used in the process must provide precise focal length control and multi-axis movement with automated capture capabilities. In addition, the axial capture capabilities of the apparatus must enable seamless stitching solutions for macro and micro photography subjects.

### SUMMARY OF THE INVENTION

To minimize the limitations found in the prior art, and to minimize other limitations that will be apparent upon the reading of the specifications, the present invention provides a method for generating seamless mosaic images from multi-axis and multi-focus photographic data of at least one subject. The method comprising the steps of performing axial capture of a plurality of images of the at least one subject, sorting the plurality of images into a plurality of folders for easier processing of the plurality of images, performing focus stacking process for analysis of images, depth calculations, extracting data and rendering a focus stacked image, performing post processing of the focus stacked images to enhance the images, performing photo mosaic stitching process for rendering a seamless image and performing post processing of the seamless image to correct errors of the seamless image and to add any desired enhancements to the seamless image.

The present invention further provides a system for performing the above method of generating seamless mosaic images from multi-axis and multi-focus photographic data of at least one subject comprising at least one camera for mounting on a camera mount, at least one lens for mounting on a lens mount, at least one lighting equipment for lighting the at least one subject during the capturing process, at least one platform for placing the at least one subject to be photographed, at least one electronic control system for providing precise control of the positioning of the at least one subject in relation to the camera and the lens and a plurality of rails and/or guides for precise alignment and movements of the lens. At least one apparatus software assists in axial capturing of the at least one subject and automation of photography and the focal length of the at least one lens which can be varied by precise, repeatable, controllable movements in at least three axes of movement of the lens in relation to the subject thereby providing seamless mosaic imagery of the at least one subject.

One objective of the invention is to provide a method for generating seamless mosaic images from multi-axis and multi-focus photographic data of at least one subject.

A second objective of the invention is to provide a complete unified process for bringing disparate techniques together for the purpose of creating high resolution, high depth of field images according to the present invention.

A third objective of the invention is to provide a high precision system allowing precise focal length control and multi-axis movement with automated capture capabilities.

A fourth objective of the invention is to provide axial capture capabilities to the high precision system to enable seamless stitching solutions for at least one subject to be photographed.

A fifth objective of the invention is to provide a solution to depth of field limitations in mosaic photography through the use of an automated, precise, and efficient axial capture method and apparatus that accurately varies the focal length of the lens.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a three-axis prototype system used for generating seamless mosaic images from multi-axis and multi-focus photographic data of at least one subject;

FIG. 2 is an operational flowchart illustrating a method for generating seamless mosaic images from multi axis and multi-focus photographic data of the at least one subject;

FIG. 3 is an example of an apparatus for use with macro lenses and bellows assembly according to a preferred embodiment of the present invention;

FIG. 4 is an example of an eagle feather image created from 7,584 photographs using the three-axis prototype system of FIG. 1;

FIG. 5 is a screen capture of at least one apparatus software used to create the eagle feather image example in FIG. 4;

FIG. 6 is a diagram with examples of photographs used in and created with a focus stacking process;

FIG. 7 is an example of a depthmap of the at least one subject compared with a photograph of the same subject; and

FIG. 8 is a diagram presenting the differences between a single photograph, a plurality of photographs used in the focus stacking process, the plurality of photographs used in a mosaic stitching process, and a three-dimensional arrangement of photographs used in the method of the invention to capture the plurality of photographs of the at least one subject.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

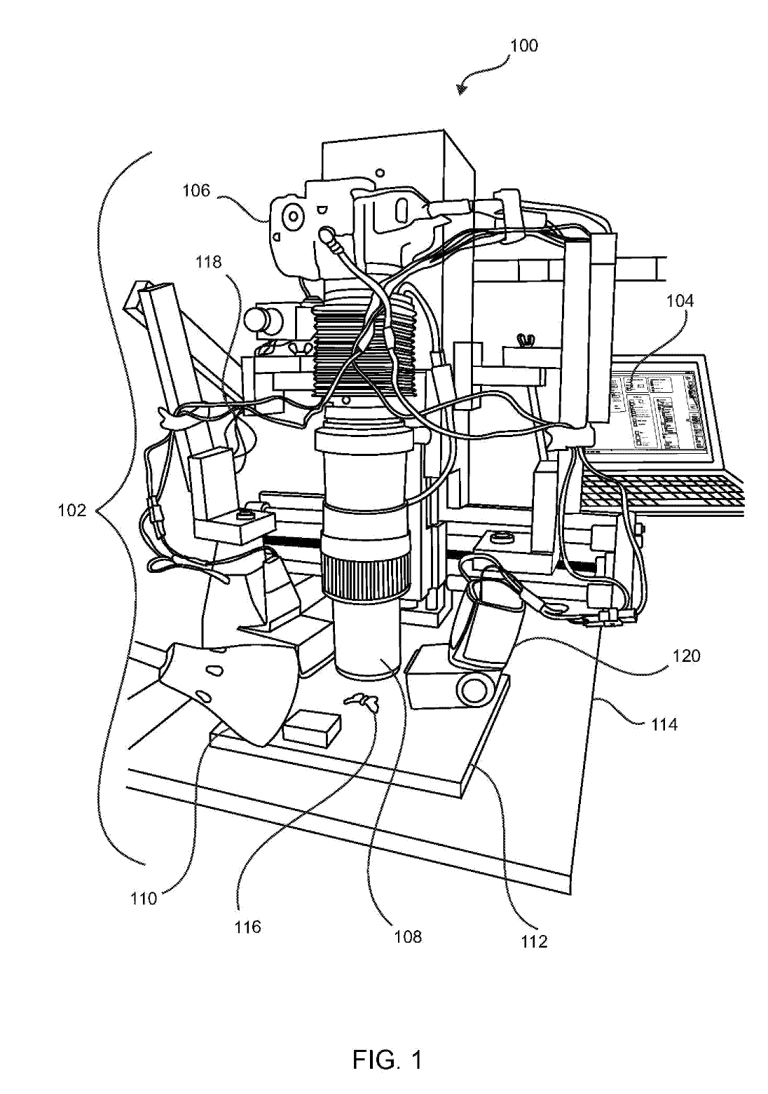

FIG. 1 is a three-axis prototype system 100 used for generating seamless mosaic images from multi-axis and multi-focus photographic data of at least one subject. The system 100 includes an apparatus 102 and at least one apparatus software 104. The apparatus 102 comprises at least one camera 106, at least one lens 108, at least one lighting equipment 110, at least one platform 112, at least one electronic control system (not shown), a plurality of rails and/or guides (not shown) for precise alignment and movements of the at least one lens 108, at least one base structure 114 for providing secure mounting points to the system 100, and at least one structural support member 118. The at least one electronic control system (not shown) provides precise control of the positioning of at least one subject 116 in relation to the at least one camera 106 and the at least one lens 108. The at least one electronic control system (not shown) also includes at least one micro controller (not shown), a plurality of servo and/or stepper motors (not shown), at least one electronic shutter release (not shown), at least one controller software (not shown), a plurality of limit switches (not shown), a plurality of relays (not shown), and necessary wiring (not shown). The micro controller serves as the primary controller for the physical hardware in the system 100. The at least one apparatus software 102 communicates with the micro controller and provides software-based features. For microscopic subjects, the at least one platform with transparent and/or semitransparent center allows illumination of the microscopic subject from underneath the platform.

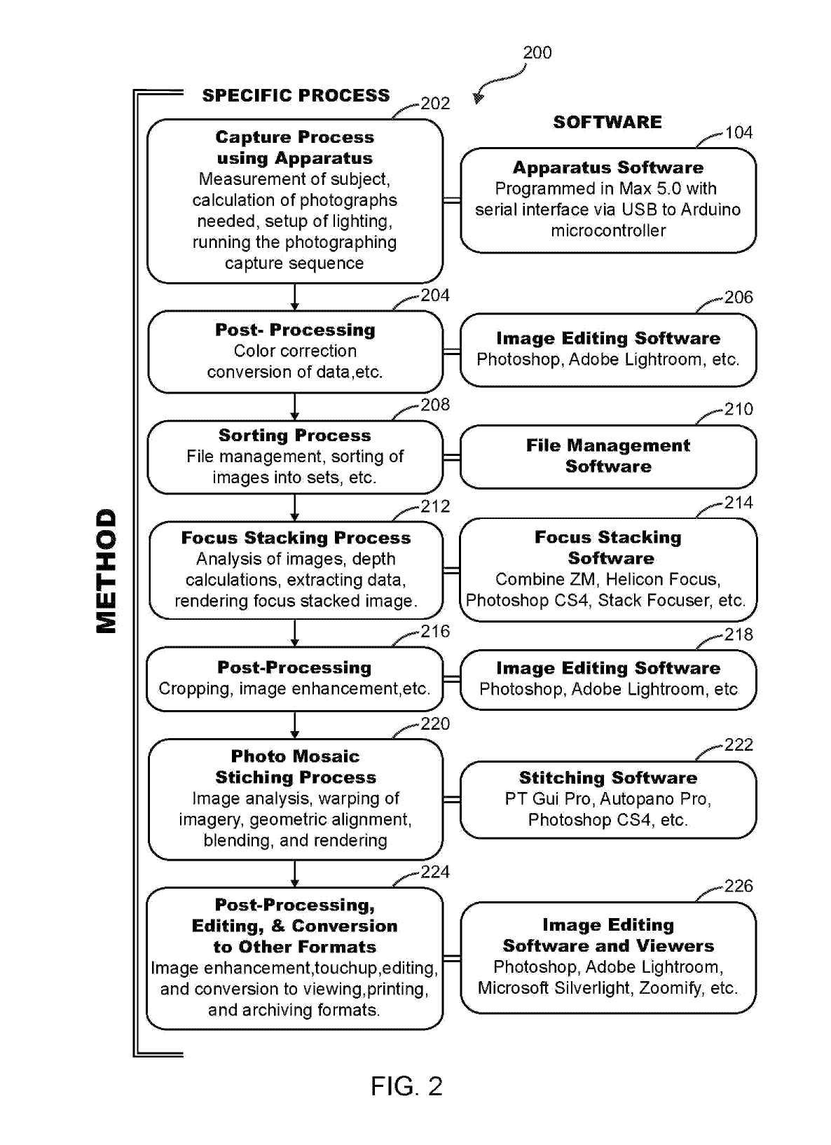

The system 100 may also include a plurality of gears (not shown) such as sprockets or worm gears. The at least one subject 116 to be photographed may fall within a range of 2 mm×2 mm and 12 inches×12 inches. The system 100 enables researchers, scientists, and the general public to capture highly detailed imagery of any macroscopic or microscopic subject. The system 100 can also be designed as an open framework that can be expanded upon and modified to accomplish tasks beyond its primary use. In all cases, the position of the at least one camera 106, position of the at least one platform 112, camera shutter release (not shown), and focus of the at least one lens 106 are controllable. The system 100 is also designed to accommodate a variety of cameras, lenses, and lighting equipment. In one exemplary embodiment a Canon Digital SLR (Single Lens Reflex) Model T1i may also be used in conjunction with a MP-E65 mm lens, and two portable off-camera flash units 120 may be used. FIG. 2 is an operational flowchart, illustrating a method for generating seamless mosaic images 200 from multi-axis and multi-focus photographic data of the at least one subject. The method 200 is initiated by axial capturing of a plurality of images of the at least one subject as indicated at block 202. Then, post processing of the plurality of images is done as indicated at block 204. After post processing of the plurality of images, the plurality of images is sorted into a plurality of folders as indicated at block 208. Optionally, the plurality of images is sorted for easier processing of the images in focus stacking process as indicated at block 212. The focus stacking process renders a focus-stacked image, which is then optionally post processed to enhance the images as indicated at block 216. Then, as indicated at block 220, photo mosaic stitching process is performed for rendering a seamless image. Finally, as indicated at block 224, the seamless image is optionally post processed to correct errors in the photo mosaic stitching process and to add any desired enhancements to the seamless image.

The at least one apparatus software 104 assists in the process indicated at block 202. The capturing process includes setup of the capture process and automation of the photography. The process indicated at block 202 uses the three axis prototype system 100 in FIG. 1. A number of settings are available to aid in the capture process such as editable values for the dimensions of the object, percentage of overlap, timing between photographs, auxiliary triggers for flash and camera controls, etc. Additional features such as control of lighting, camera settings, file format settings, timing, sequencing, and presets can be added to the at least one apparatus software as needed. The at least one camera 106 used is preferably a SLR based digital camera with complimentary metal-oxide semiconductor (CMOS) or charge-coupled device (CCD) sensor. Film based cameras or scanning cameras can also be used. Direct electrical power (from a DC or AC power source) is optimal in place of batteries for the digital cameras. A memory card with sufficient capacity may also be used and switched out during the photography process. An alternative to using a memory card is to use a direct download source and setting for the camera to download photographs directly for processing as they are taken.

At least one lighting equipment 110 is used to light the at least one subject 116 during the photography process. The optimal lighting method is flash and/or strobe based lighting. In this case, one or more flash units are adjusted to illuminate the subject with the desired effect. The flash and/or strobe units are subsequently triggered by the camera through a hot shoe flash adapter and cable. Multiple flash/strobe units can be used and are commonly synchronized. Another preferred lighting method includes flash or LED ring lights that are typically mounted on the lens and provide very even illumination. Other lighting may be used such as incandescent bulb or tungsten lights. For microscopic subjects, the same lighting methods can be used with the point of illumination coming from underneath the at least one platform.

For the capturing process, the at least one subject 116 to be photographed is measured and a bounding box is determined. The bounding box defines the outer edges of the at least one subject 116 in the X, Y and Z axes. The entire area of the bounding box will typically be photographed using the apparatus 102. However, in some cases, an operator may choose to photograph at least one subject 116 through a different method. The bounding box method is the more inclusive of the options. Once the dimensions of at least one subject 116 and bounding box are determined, the resulting values are entered into the at least one apparatus software 104. The measurement of the bounding box can be accomplished manually through standard measuring techniques (such as a ruler or caliper) or through the use of the capture program to compute and define the box based positional information from the apparatus. Two key values that are needed before photography can begin are the amount of overlap between images, and the distance between photographs in the f-axis. Typically, a 20-40% overlap between images is desired on all sides of the photograph. As little as 1% overlap may be used; however, results are typically optimal with 20-40%. The distance between photographs in the f-axis is based on a different set of factors. In this case, the distance is based on the lens, aperture, and focal length. The lens, aperture, and focal length factor together to determine how much of the at least one subject 116 is in focus. The resulting amount of area that is in clear sharp focus is measured along the f-axis and is also referred to as the depth of field. Between photographs, it is optimal to have at least 20% overlap in the depth of field of the photographs. If the depth of field is measured to be 1 mm and 25% overlap is desired, then the spacing between photographs on the f-axis would be 0.75 mm. Once the desired percentage of overlap and distance between photographs along the f-axis is determined, the resulting values are entered into the at least one apparatus software program 104. Given the dimensions (and/or bounding box) along with the percentage of overlap and distance between photographs along the f-axis, the apparatus software program can then automatically calculate the number of photographs needed to photograph the entire subject with the desired level of detail. Although the apparatus software program 104 calculates everything for the operator, the operator can still override any setting or calculation manually. Additional settings can be specified in the apparatus software program 104 such as timing between photographs, lighting triggers, etc. These values provide for flash recharge time, servo/stepper motor movement time, camera recording time, etc. and are valuable settings that are all adjustable in the at least one apparatus software program 104. Once the settings are finalized, photographs are taken. The operator can start, stop, pause, continue, and skip photographs at any time. Once the sequence is started, the apparatus 102 will continue to take photographs until the number of photographs is complete or the operator pauses or stops the process. The operator may need to pause to change battery and/or memory card for the camera.

After the desired number of photographs is captured, the photographs are post processed. The post processing is done with at least one image editing software 206 which allows any manipulation that is desired to enhance each photograph prior to the focus-stacking process. These manipulations may include sharpening, cropping, adjusting the RAW values (if the RAW format is used), adjusting the color balance, etc. Preferably, to allow complete compatibility with at least one focus stacking software 214, the post processing process may involve converting the photographs to a JPEG or TIFF format if needed. Each set of photographs having the same X and Y locations are sorted into a separate folder using at least one file management software 210. While this is optional and not required for the process, it does provide opportunity to adjust the images, prepare them for the next steps, and improve efficiency.

The focus stacking process is accomplished with the at least one focus-stacking software program 214 and involves the basic process of merging very specific areas of multiple photographs into a single photograph. The most common process involves analyzing each set of photographs, processing the analyzed data, extracting the areas of the image that have the desired focus, then rendering and outputting a final image. In one example, Combine ZM focus-stacking software by Alan Hadley was used. The set of photographs loaded into the focus-stacking software program 214 is processed by the program in that the program aligns all frames, finds detail in each frame, removes islands (or artifacts) from the frames, fills the blank spaces of the frames, creates a lowpass filter, filters and replaces depthmap, interpolates output, and makes a new frame from the output. These processes are specific to the Combine ZM software. Other software programs such as Helicon Focus and Zerene Stacker offer different settings and specific processes to analyze and process the images, but they yield a similar end result. During some focus-stacking processes, a depthmap can be used and created which provides a three-dimensional representation of the subject being photographed. In this instance, for each set of photographs that are merged into a single focus stacked photograph, a corresponding depthmap can be output at the same time.

After the focus stacking process, the resulting focus stacked images are optionally post processed to enhance the images. The image enhancement is accomplished with at least one editing software 218 and includes cropping the photograph, removing artifacts from the focus stacking process, and other processes that may provide a more suitable photograph for the next step of the process, the photo mosaic stitching process.

The photo mosaic stitching process is accomplished with at least one stitching software program 222 designed to “stitch” and assemble a set of images into a single image. A number of software programs are available for photo mosaic stitching process including Autopano Pro, PT Gui Pro, and Photoshop CS4. The stitching process involves loading the focus stacked images, analyzing the images, applying warping algorithms to the images, aligning the images, making adjustments and optimizations to the alignment, blending of the images, and rendering the final mosaic into a seamless image. The final seamless mosaic image is optionally post processed using at least one image editing software 226 to correct for any errors in the stitching process and to add any desired image enhancements.

Once image enhancements and post-processing are complete, the seamless image can be converted and output to different formats and viewing applications. Other formats and viewing applications may include the Zoomify viewing application format for online viewing, Microsoft Silverlight or HDView viewing formats, and JPG2000 formats. In many cases, the optimal method of displaying images via internet is to break the image into multiple sets of small image tiles which can then be rapidly read and processed by online programs such as Flash, Google Maps, Microsoft Silverlight, etc.

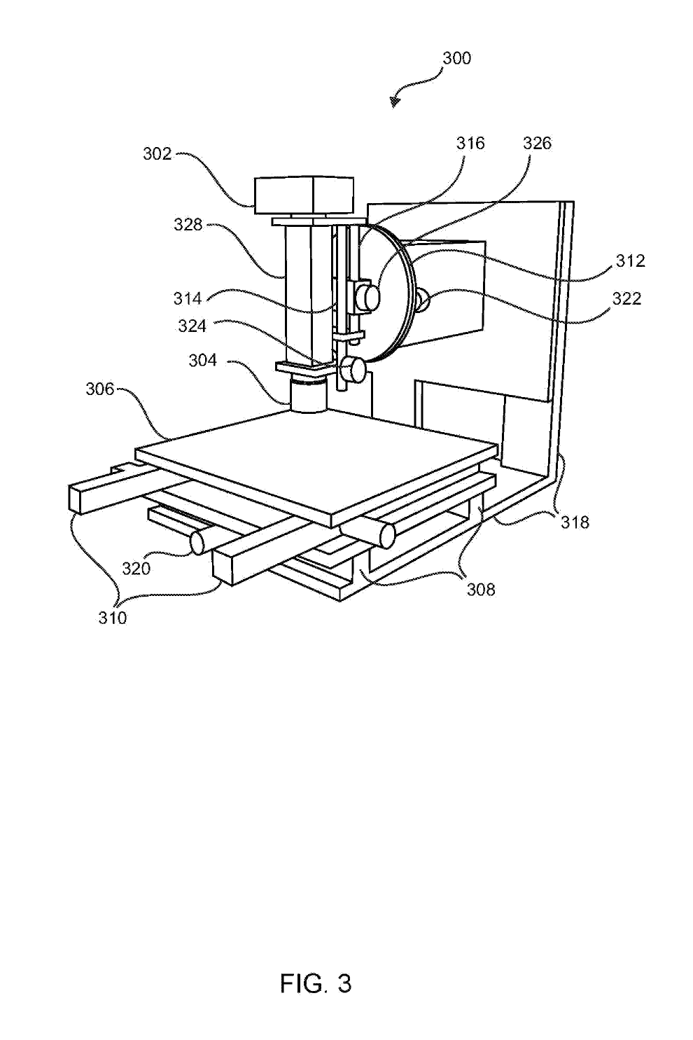

FIG. 3 is an example of an apparatus for use with macro lenses and bellows assembly according to a preferred embodiment of the present invention. The apparatus 300 is an electronically controlled device with precise, repeatable, controllable movements in at least three axes and includes capability of adjusting the focus or focal length of lenses. The apparatus 300 comprises of at least one camera 302 for mounting on a camera mount, at least one lens 304 for mounting on a lens mount, at least one lighting equipment (not shown), at least one platform 306, at least one electronic control system (not shown), a plurality of rails and/or guides (308, 310, 312, 314, 316) for precise alignment and movements of the at least one lens 304, at least one base structure 318 for providing secure mounting points to the apparatus 300, and a plurality of servo and/or stepper motors (320, 322, 324, 326) for each axis of movement. The movements in X, Y, and F are three axes of movement that are required in the preferred embodiment. The movement in the X and Y axes provide adjustments in position that are parallel to the at least one lens 304. The adjustment of the f-axis involves an internal adjustment in the lens and/or a movement that adjusts the focal length of the lens to the desired position. Additional adjustments are not required but provide options that may be desired for specific applications.

The additional adjustments may include but are not limited to a movement in the Z, U, and V axes which can control the distance of the camera body to the subject (Z) and rotation of the camera and lens in two independent axis (U and V). The ability to adjust the focal length of the at least one lens 304 is accomplished in different ways depending on the at least one lens 304 being used and at least one subject (not shown) being photographed. The apparatus 300 is designed to be reconfigured to adjust for differences between lenses and camera types. When using fixed focus lenses, the at least one lens 304 is translated perpendicular to the at least one subject (not shown). When using adjustable focus lenses, the at least one lens 304 is rotated and/or translated using a physical or electronic connection to its designed means of adjustment. The preferred lens configuration is one in which the at least one lens is adjustable independent from the at least one camera 302 and the at least one subject (not shown) being photographed. This preferred configuration uses a bellows assembly 328 in conjunction with the camera 302 and lens 304 to provide precise adjustment capabilities. In this configuration, the camera 302 and the lens 304, and bellows assembly 328 are able to move in the Z-axis with independent movement of the lens 304 and front of the bellows assembly 328 along the f-axis. Movements in additional axes such as the Z or V axes provide additional position adjustments of the at least one camera 302 and at least one lens 304 in relation to the at least one subject (not shown). These position adjustments can be used to photograph the subject from different angles and distances.

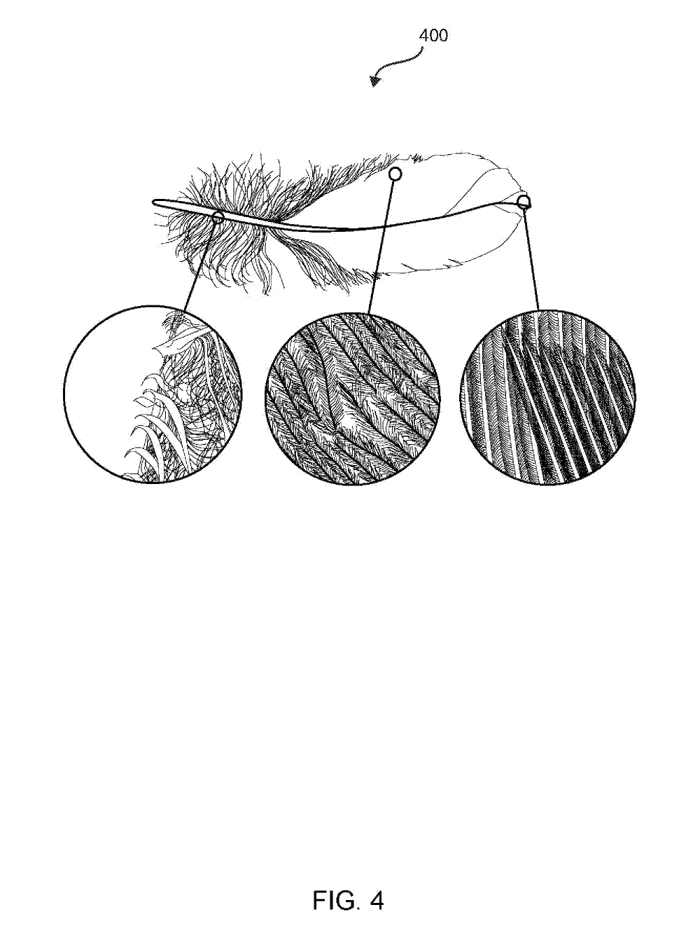

FIG. 4 is an example of an eagle feather image 400 created from 7,584 photographs using the three-axis prototype system of FIG. 1 and the method disclosed in FIG. 2. For producing the example of the eagle feather image 400, PT Gui Pro version 8.1.2 was used to produce a seamless mosaic eagle feather image and output as a PSB (Photoshop Large Document Format) image with a file size of 11 Gigabytes and resolution over 6.5 gigapixels. The process of creating the eagle feather image in FIG. 4 may take approximately 4 hours. Using manual controls to accomplish the same task is feasibly prohibitive and is the primary reason why no comparable seamless mosaic has been done to date.

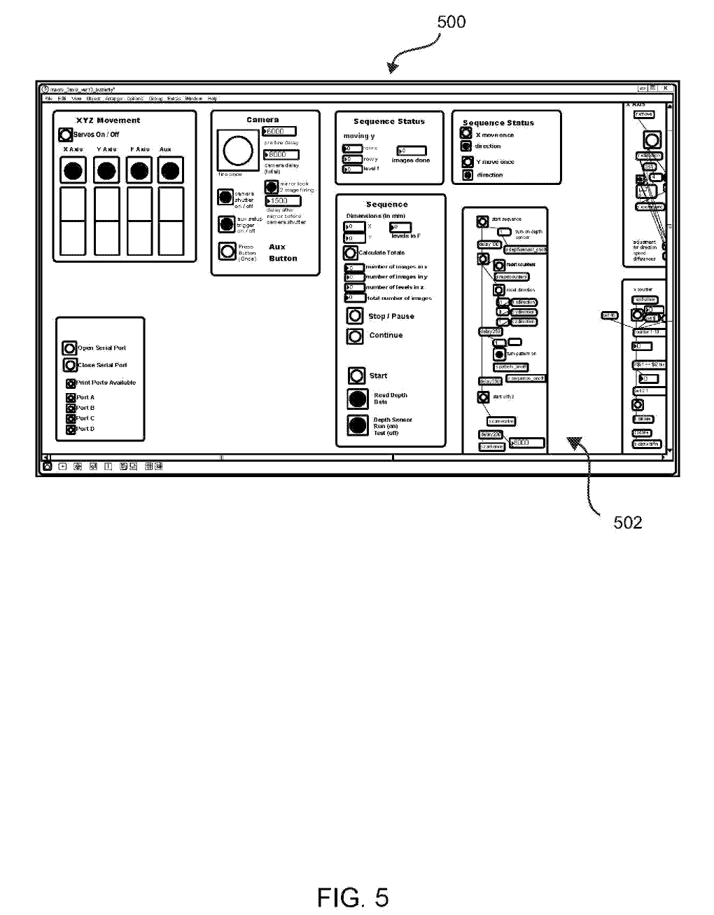

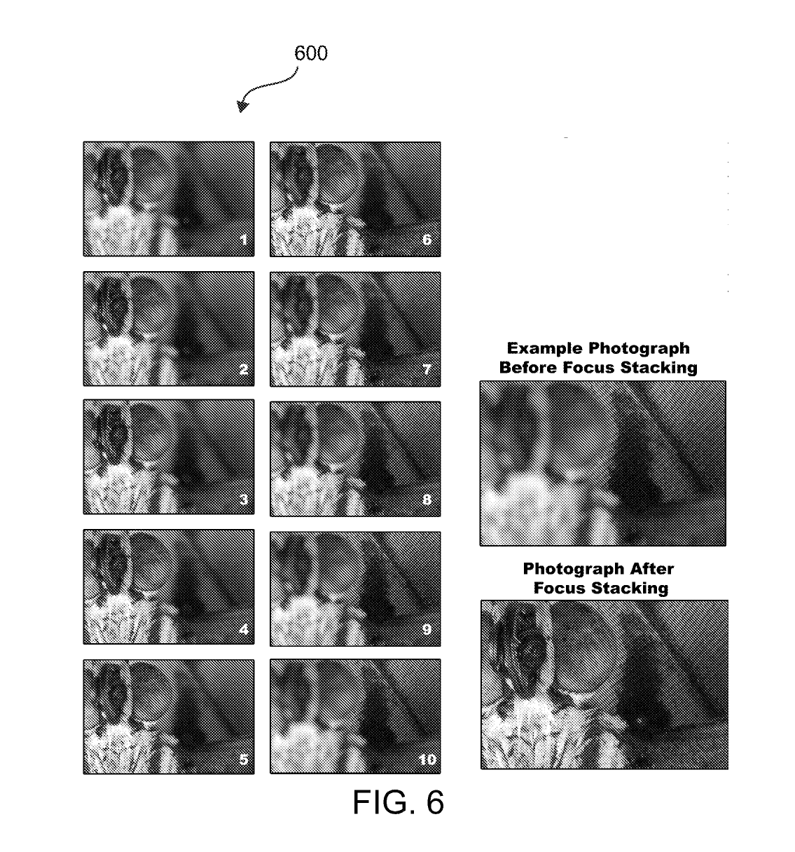

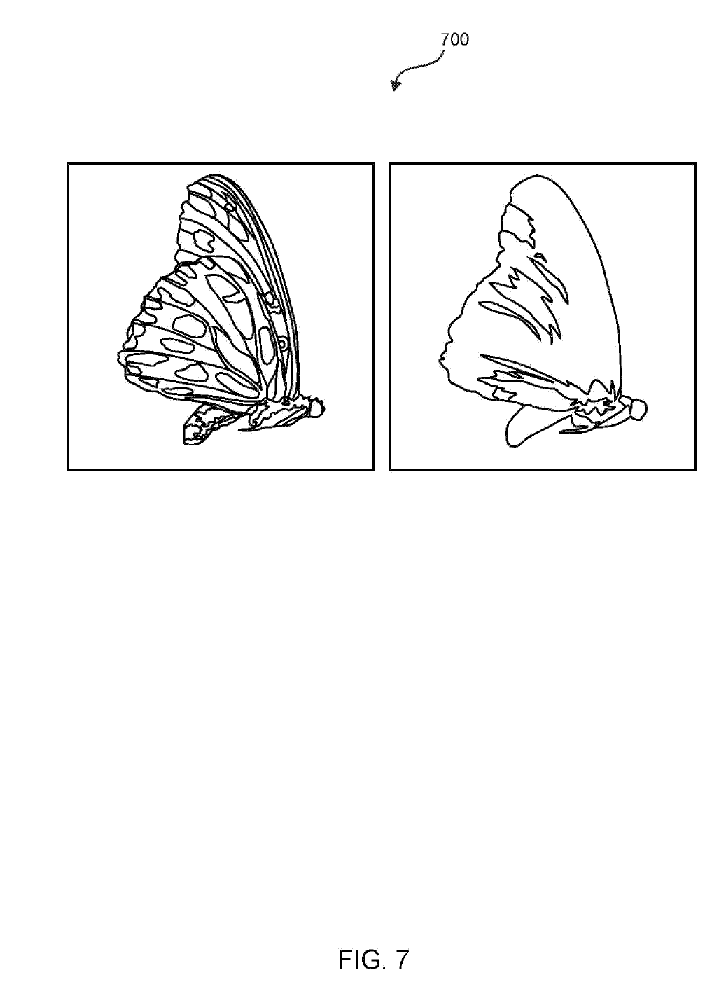

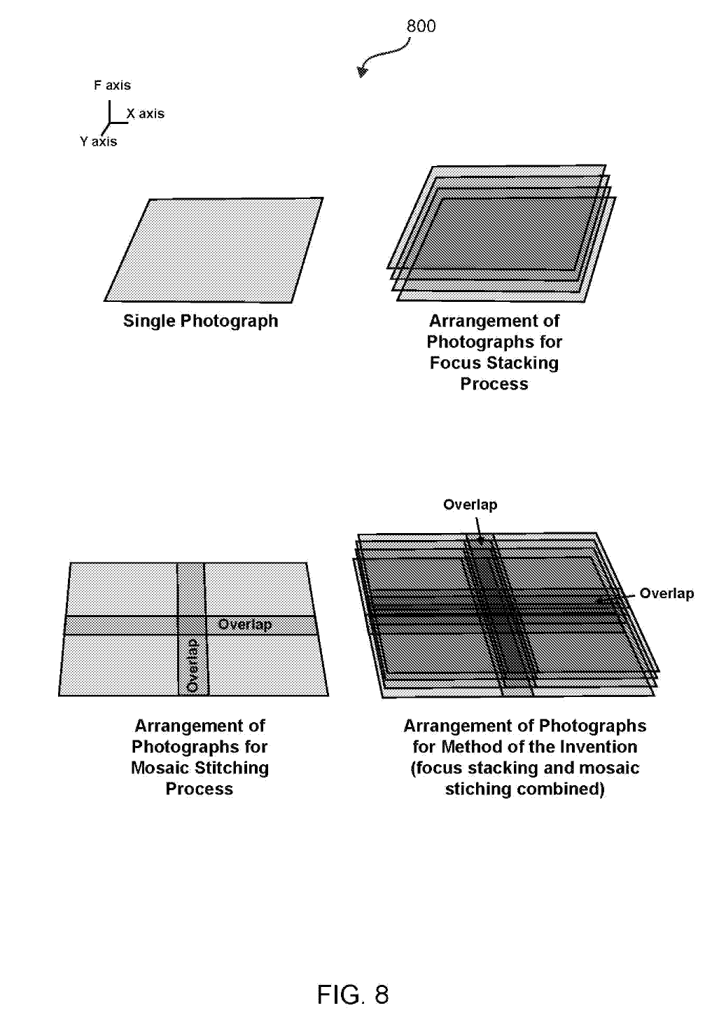

FIG. 5 is a screen capture of at least one apparatus software 500 used to create the eagle feather image example in FIG. 4. The at least one apparatus software 502 communicates with the micro controller and provides software-based features. Referring to FIG. 6, a diagram 600 with examples of photographs used in and created with the focus stacking process is illustrated. In the diagram 600, photographs are used that were taken with varying focal lengths and merging areas of each photograph that has the sharpest or most desired focus. In order to explain differences in depthmap image and photograph, FIG. 7 shows an example of a depthmap of the at least one subject 700 compared with a photograph of the same subject. For obtaining a high-resolution depthmap as shown in FIG. 7, depthmap images are used in the stitching process in addition to the focus stacked images. This process requires slight variation to the method disclosed in FIG. 2. In the process of obtaining the high-resolution depthmap, the focus-stacked images are loaded, analyzed, stitched, and aligned. The information used for these images is translated to apply to the depthmap images. Then the final depthmap is blended and rendered into a seamless mosaic image. The resulting seamless mosaic depthmap image may be used to provide additional information and image enhancements to the original photograph and can also be used to create three-dimensional geometric models and finally, FIG. 8 is a diagram 800 presenting the differences between a single photograph, a plurality of photographs used in the focus stacking process, the plurality of photographs used in a mosaic stitching process, and a three-dimensional arrangement of photographs used in the method of the invention to capture the plurality of photographs of the at least one subject 116.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

I claim:

1. A method for generating seamless mosaic images from multi-axis and multi-focus photographic data of at least one subject, the method comprising the steps of:
(a) performing axial capture of a plurality of images of the at least one subject;
(b) performing focus stacking process for analysis of images, calculations, extracting data and rendering a plurality of focus stacked images; and
(c) performing photo mosaic stitching process for rendering a seamless image.

2. The method of claim 1 wherein the at least one subject may fall within a range of 2 mm×2 mm and 12 inches×12 inches.

3. The method of claim 1 further comprising the step of performing post processing of the plurality of images of that at least one subject.

4. The method of claim 3 wherein the step of performing post processing comprises enhancing the focus stacked images.

5. The method of claim 4 further comprising performing post processing of the seamless image to correct errors of the seamless image and to add any desired enhancements to the seamless image.

6. The method of claim 1 further comprising the step of sorting the plurality of images into a plurality of folders for easier processing of the plurality of images.

7. The method of claim 1 further comprising the step of performing post processing of the seamless image to correct errors of the seamless image and to add any desired enhancements to the seamless image.

8. The method of claim 7 wherein the post processing of the at least one subject enhances the images prior to the focus stacking process.

9. The method of claim 1 wherein the post processing of the focus stacked images is accomplished with image editing software.

10. The method of claim 1 wherein the photo mosaic stitching process is accomplished with stitching software.

11. The method of claim 1 wherein the post processing of the seamless image is accomplished with image editing software.

12. An apparatus for capturing multi-axis and multi-focus photographic data of at least one subject, comprising:
at least one camera for mounting on a camera mount;
at least one lens for mounting on a lens mount;
at least one lighting equipment for lighting the at least one subject;
at least one platform for placing the at least one subject to be photographed;
at least one electronic control system for providing precise control of the relative positions of the at least one subject to the at least one camera and the at least one lens; and
whereby at least one apparatus software assists in axial capturing of the at least one subject and automation of photography and the focal length of the at least one lens which can be varied by precise, repeatable, controllable movements in at least three axes of movement of the at least one lens thereby providing seamless mosaic imagery of the at least one subject.

13. The apparatus of claim 12 wherein at least one base structure provides secure mounting points to the apparatus.

14. The apparatus of claim 12 wherein the apparatus may include a plurality of gears.

15. The apparatus of claim 14 wherein the plurality of gears may be sprockets.

16. The apparatus of claim 14 wherein the plurality of gears may be worm gears.

17. The apparatus of claim 12 wherein the at least one subject may fall within a range of 2 mm×2 mm and 12 inches×12 inches.

18. The apparatus of claim 12 wherein the at least one electronic control system includes at least one micro controller, a plurality of servo and/or stepper motors, at least one electronic shutter release, at least one controller software, a plurality of limit switches, a plurality of relays, and necessary wiring.

19. The apparatus of claim 19 wherein a preferred configuration of the at least one electronic control system may use an adjustable lens.

20. The apparatus of claim 19 wherein the at least one adjustable lens may use a plurality of bellows in conjunction with the at least one camera and the at least one lens.

21. The apparatus of claim 12 wherein the at least one camera may be a single lens reflex based digital camera with CMOS sensor.

22. The apparatus of claim 12 wherein the at least one camera may be a single lens reflex based digital camera with CCD sensor.

23. The apparatus of claim 12 further comprising a plurality of guide for precise alignment and movements of the at least one lens.

24. The apparatus of claim 12 wherein the at least one platform further comprises a transparent and/or semitransparent center such that microscopic subjects are illuminated from underneath the at least one platform.
